(19) United States
(12) Patent Application Publication
(10) Pub. No.: US 2016/0236220 A1
(43) Pub. Date: Aug. 18, 2016

(54) MASK FRAME ASSEMBLY AND METHOD OF MANUFACTURING THE SAME

(71) Applicant: SAMSUNG DISPLAY CO., LTD., Yongin-si (KR)

(72) Inventors: Youngmin Kim, Yongin-si (KR); Kiehyun Nam, Yongin-si (KR); Youngkwan Kim, Yongin-si (KR); Hakjoong Yong, Yongin-si (KR); Heungkyoon Lim, Yongin-si (KR)

(21) Appl. No.: 14/882,192

(22) Filed: Oct. 13, 2015

(30) Foreign Application Priority Data
Feb. 16, 2015 (KR) 10-2015-0023150

(51) Int. Cl. B05B 15/04; B29C 41/02; B29C 41/34; B29C 65/00

(52) U.S. Cl. CPC B05B 15/045; B29C 66/05; B29C 41/02; B29C 41/34; B29K 2079/08

(57) ABSTRACT

A mask frame assembly includes: a mask including a pattern hole; and a frame supporting the mask, wherein the mask includes a polymer material including a magnetic element.

### CROSS-REFERENCE TO RELATED APPLICATION

This application claims priority to and the benefit of Korean Patent Application No. 10-2015-0023150, filed on Feb. 16, 2015, in the Korean Intellectual Property Office, the disclosure of which is incorporated herein in its entirety by reference.

### BACKGROUND

1. Field

One or more example embodiments relate to a mask frame assembly and a method of manufacturing the same.

2. Description of the Related Art

In a thin film manufacturing process, for example, a process of forming a thin film of an organic-light emitting display apparatus, a deposition technique for depositing a thin film onto a substrate by using a vapor deposition source may be used. That is, a mask frame assembly is positioned on a substrate, and a deposition vapor passes through a pattern hole formed in a mask of the mask frame assembly to form a thin film having a desired pattern on the substrate.

The above information disclosed in this Background section is only for enhancement of understanding of the background of the invention and therefore it may contain information that does not form the prior art that is already known in this country to a person of ordinary skill in the art.

### SUMMARY

One or more example embodiments include a mask frame assembly frequently used in a thin film manufacturing process and a method of manufacturing the mask frame assembly.

Additional aspects will be set forth in part in the description which follows and, in part, will be apparent from the description, or may be learned by practice of the presented example embodiments.

According to one or more example embodiments, a mask frame assembly includes: a mask including a pattern hole; and a frame supporting the mask, wherein the mask includes a polymer material comprising a magnetic element.

The magnetic element may include at least one of steel (Fe), strontium (Sr), graphene, nickel (Ni), cobalt (Co), copper alloy, neodymium (Nd), dysprosium (Dy), or samarium (Sm).

The polymer material may include polyimide.

The frame may be coupled to an edge of the mask.

A length of the magnetic element may be smaller than a thickness of the polymer.

According to some example embodiments of the present invention, in a method of manufacturing a mask frame assembly, the method includes: forming a polymer layer including a magnetic element on a glass substrate; forming a pattern hole in the polymer layer; coupling a frame to an edge of the polymer layer; and separating the glass substrate from the polymer layer.

The forming of the polymer layer may include: coating the glass substrate with a polymer solution comprising the magnetic element; and solidifying the polymer solution coating the glass substrate.

The forming of the pattern hole may include at least one of laser patterning, lithography, or printing.

The coupling of the frame may include providing an attachment layer at an edge of the mask and attaching the frame to the attachment layer.

The separating of the glass substrate from the polymer layer may include emitting a laser to heat the glass substrate.

### BRIEF DESCRIPTION OF THE DRAWINGS

These and/or other aspects of embodiments of the present invention will become apparent and more readily appreciated from the following description of the example embodiments, taken in conjunction with the accompanying drawings in which:

FIG. 1 is a diagram schematically illustrating a structure of a thin film deposition apparatus to which a mask frame assembly is applied, according to an example embodiment of the present invention;

FIG. 2 is a perspective view illustrating the mask frame assembly of FIG. 1;

FIG. 3 is an enlarged diagram of a portion A of FIG. 2; and

FIGS. 4A to 4F are diagrams sequentially illustrating processes of manufacturing the mask frame assembly of FIG. 2.

### DETAILED DESCRIPTION

Aspects of the present invention may include various changes and numerous embodiments, example embodiments will be illustrated in the drawings and described in some detail in the written description. The aspects and features of embodiments of the present invention and the method of realizing the aspects and the features will be more clear with reference to the example embodiments described in detail below with reference to the drawings. However, aspects of the present invention may be embodied in various forms and should not be construed as being limited to the example embodiments.

The example embodiments of the present invention will be described in more detail with reference to the accompanying drawings. Like reference numerals in the drawings denote like elements, and thus their description will not be repeated.

An expression used in the singular encompasses the expression of the plural, unless it has a clearly different meaning in the context.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “formed on” another layer, region, or component, it can be directly or indirectly formed on the other layer, region, or component. That is, for example, intervening layers, regions, or components may be present.

Sizes of components in the drawings may be exaggerated for convenience of explanation. In other words, because sizes and thicknesses of components in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to or different from the described order.

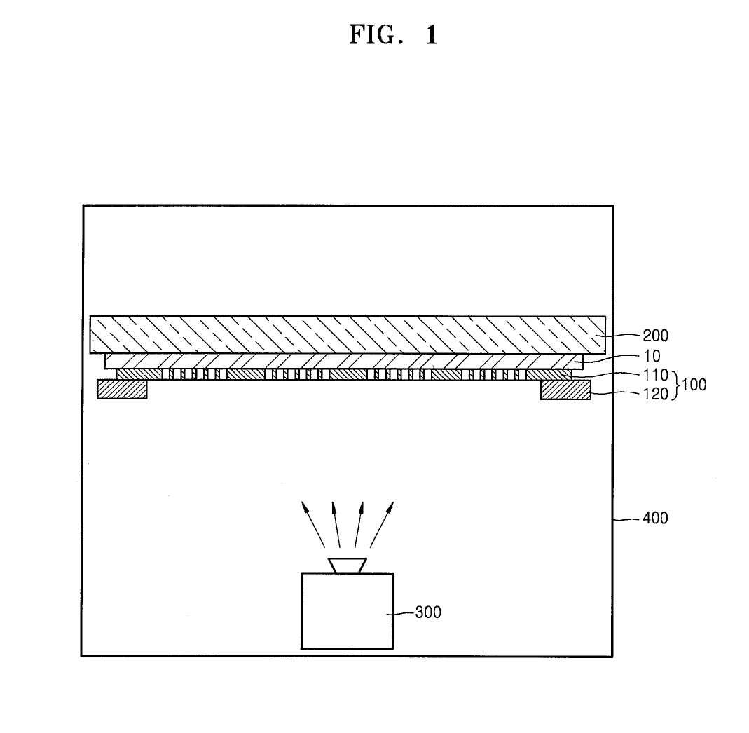

FIG. 1 is a diagram schematically illustrating a structure of a thin film deposition apparatus to which a mask frame assembly 100 is applied, according to an example embodiment.

As shown in FIG. 1, the thin film deposition apparatus includes the mask frame assembly 100 according to the present example embodiment, which includes a mask 110 for forming a pattern (e.g., a predetermined or desired pattern) on a substrate 10 (i.e., a deposition target), a chucking magnet 200 attaching or securing the mask 110 to the substrate 10 using magnetic force, and a deposition source 300 emitting deposition gas into a chamber 400. A frame 120 of the mask frame assembly 100 supports the mask 110 (e.g., by supporting the periphery or edges of the mask 110).

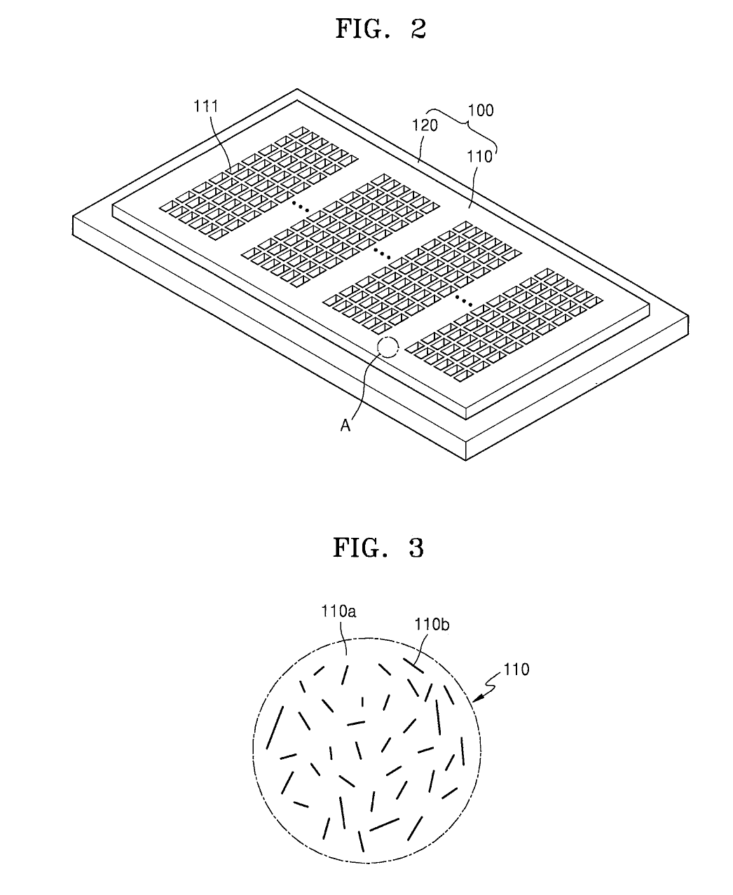

Therefore, when the deposition source 300 emits the deposition gas into the chamber 400, the deposition gas may pass through a pattern hole (111 of FIG. 2) and be deposited onto the substrate 10, thereby forming a thin film having a pattern (e.g., a predetermined pattern).

The chucking magnet 200 may pull the mask 110 by using a magnetic force so that the substrate 10 and the mask 110 are firmly or securely attached to each other. If a central portion of the mask 110 bends downward during deposition due to its weight, the substrate 10 and the mask 110 may not be firmly attached and a gap may form therebetween, which may lead to deposition defects such as shadowing. Accordingly, in some embodiments, the substrate 10 and the mask 110 may be firmly attached to each other to improve deposition quality.

Considering the above, the mask 110 may be formed by using a magnetic element such as a metal that may be easily pulled by the magnetic force of the chucking magnet 200.

However, if the mask 110 is formed by using only metal, it may be difficult to precisely form pattern holes (111 of FIG. 2). Recently, as a size of the substrate 10 increases, demands for a large mask is also increasing; however, it may not be convenient to precisely form many pattern holes on a large metal plate. Therefore, because productivity may be decreased, a method of easily forming precise pattern holes may be used.

The mask 110 according to the present example embodiment may improve deposition as described above.

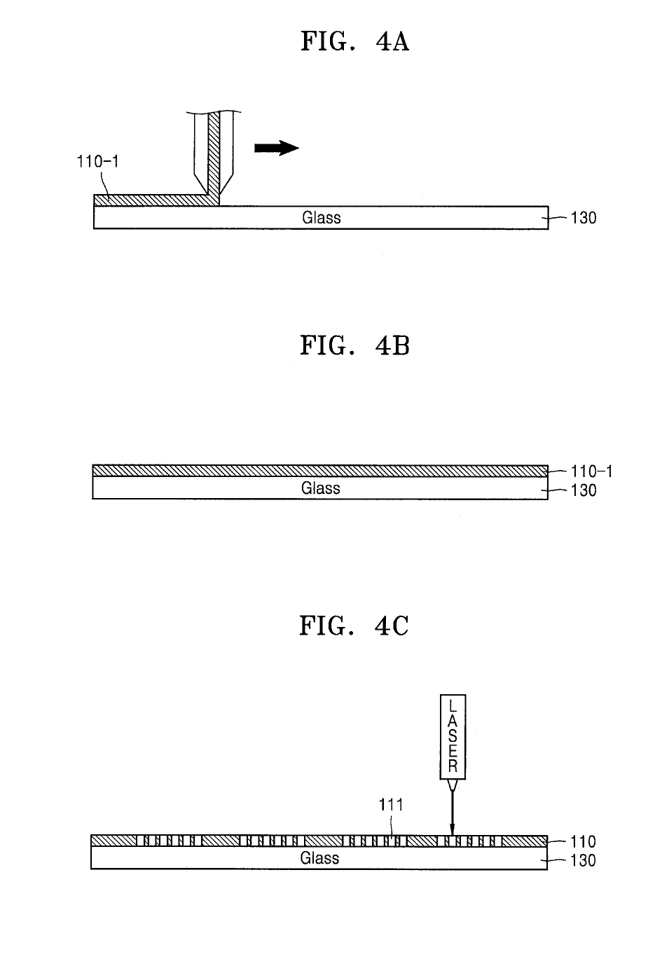

FIG. 2 is a perspective view illustrating the mask frame assembly 100 according to the present embodiment including the mask 110 and the frame 120. FIG. 3 is an enlarged diagram of a portion A of the mask 110 of FIG. 2.

First, referring to FIG. 2, the mask frame assembly 100 includes the mask 110 in which pattern holes 111 are formed, and the frame 120 that is coupled to edges of the mask 110 and supports the mask 110, as described above.

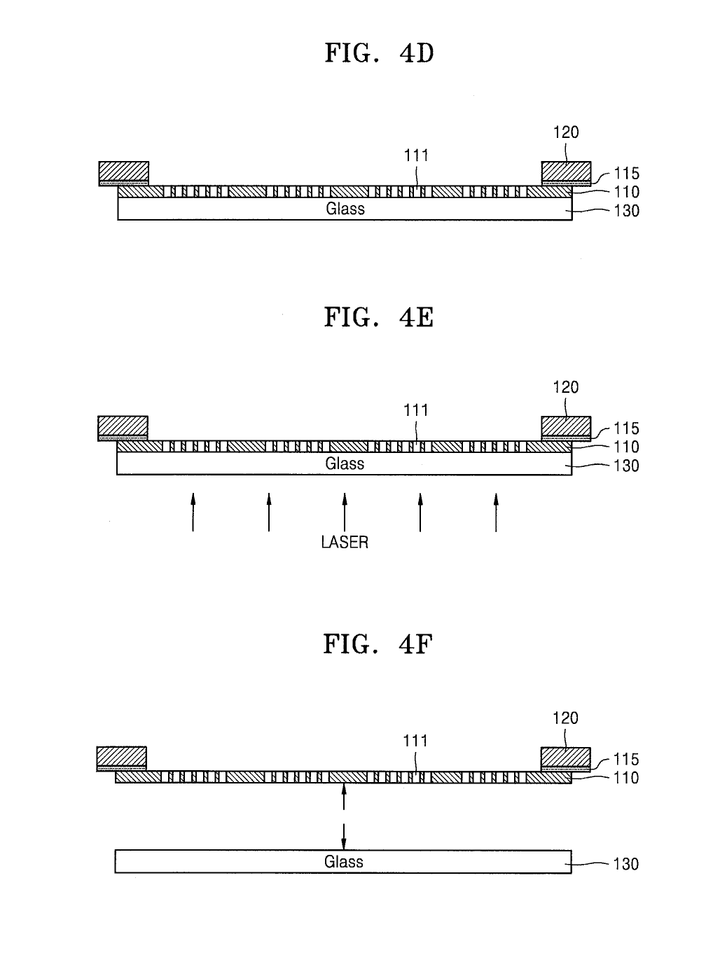

The frame 120 may be a quadrilateral having a hollow area (e.g., cavity or opening) in the middle. The frame 120 is coupled to the edges of the mask 110 by an attachment layer (115 of FIG. 4d). An area of the mask 110 in which the pattern holes 111 are formed is positioned in the hollow area of the frame 120.

As shown in FIG. 3, the mask 110 is formed of a polymer-based material including a magnetic element, for example, a polymer 110a containing a magnetic element 110b such as metal. That is, the polymer 110a is a relatively soft material in which the pattern holes 111 may easily be formed, and particles of the magnetic element 110b dispersed in the polymer 110a allow the mask 110 to be firmly attached to the substrate 10 by the magnetic force of the chucking magnet 200.

The magnetic element 110b may include a suitable magnetically conductive material including at least one of, for example, steel (Fe), strontium (Sr), graphene, nickel (Ni), cobalt (Co), copper alloy, neodymium (Nd), dysprosium (Dy), or samarium (Sm). The polymer 110a may include, for example, polyimide.

Also, the particles of the magnetic element 110b may be spherical or tubular. However, if respective sizes of the particles of the magnetic element 110b are too large, this may affect the forming of the pattern holes 111. Therefore, according to some embodiments, a minimum length of a particle of the magnetic element 110b may be less than a thickness of the polymer 110a.

When the mask 110 is formed by using the polymer 110a containing the magnetic element 110b, because of the magnetic element 110b, the mask 110 may be attached to the substrate 10 by using the magnetic force of the chucking magnet 200.

Also, because the polymer 110a is used as a base, the pattern holes 111 may be formed accurately by using a laser. That is, the requirements described above may all be satisfied.

The mask frame assembly 100 described above may be manufactured according to processes described with reference to FIGS. 4A to 4F.

First, as shown in FIG. 4A, a polymer layer 110-1 is formed on a glass substrate 130, which is a temporary supporting substrate. The mask 110 is formed from the polymer layer 110-1 via the manufacturing process, which includes coating the glass substrate 130 with a solution of the polymer 110a including the magnetic element 110b.

Second, as shown in FIG. 4B, the polymer layer 110-1 is dried and cured (e.g., solidified). Third, as shown in FIG. 4C, a laser is emitted to form the pattern holes 111. Because the base is formed of the polymer 110a, the pattern holes 111 may be easily formed by using a laser. Alternatively, any other suitable method to form the polymer layer 110a and the pattern holes 111 may be used, such as general lithography or various printing techniques. The formation of the pattern holes 111 results in the mask 110 formed of a polymer material containing a magnetic element.

Fourth, as shown in FIG. 4D, an attachment layer 115 is provided on the edges of the mask 110 and the frame 120 is attached to the attachment layer 115.

Finally, the glass substrate 130, which is a temporary supporting substrate, is removed. For example, by heating an entire surface of the glass substrate 130 by emitting a laser, adhesion strength between the glass substrate 130 and the mask 110 may be weakened, and thus the glass substrate 130 may be removed.

As shown in FIG. 4F, the glass substrate 130 is separated from the mask 110 due to the weakened adhesion strength, and thus, the mask frame assembly 100 according to the present example embodiment is manufactured.

The thin film deposition process using the mask frame assembly 100 may be performed as below.

First, as shown in FIG. 1, the substrate 10 and the mask frame assembly 100 may be mounted in the chamber 400, and the substrate 10 and the mask 110 may be attached to each other by applying the magnetic force of the chucking magnet 200. Accordingly, the mask 110 may be firmly attached to the substrate 10.

When deposition gas is emitted by the deposition source 300 in the above state, the deposition gas is deposited onto the substrate 10 via the pattern holes 111 of the mask 110, and thus a thin film with a desired pattern is formed. Because the substrate 10 and the mask 110 are firmly attached to each other by the magnetic force of the chucking magnet 200 being applied to the magnetic element 110b, instances of deposition defects such as shadowing may be prevented or reduced.

Also, because the deposition is performed via the pattern holes 111 accurately formed in a polymer-based material, a pattern may be precisely formed on the substrate 10 as desired.

Therefore, by using the mask frame assembly 100, tiny pattern holes may be easily formed and an element may be firmly attached to a substrate.

Although the above example embodiment describes that the mask 110 is formed by using a polymer-based material including a magnetic element, for example, the polymer 110a containing the magnetic element 110b physically dispersed therein, example embodiments are not limited thereto. The magnetic element 110b and the polymer 110a may be chemically combined.

That is, a method of combining two elements may be modified within the scope of the example embodiments.

As described above, according to the one or more of the above example embodiments, in the mask frame assembly 100, a pattern may be accurately formed and an element may be firmly attached to a substrate, and thus, deposition productivity may be increased and product quality may be improved.

It should be understood that the example embodiments described herein should be considered in a descriptive sense only and not for purposes of limitation. Descriptions of features or aspects within each example embodiment should typically be considered as available for other similar features or aspects in other example embodiments.

While one or more example embodiments have been described with reference to the figures, it will be understood by those of ordinary skill in the art that various changes in form and details may be made therein without departing from the spirit and scope as defined by the following claims, and their equivalents.

What is claimed is:

1. A mask frame assembly comprising:
a mask comprising a pattern hole; and
a frame supporting the mask,
wherein the mask comprises a polymer material comprising a magnetic element.

2. The mask frame assembly of claim 1, wherein the magnetic element comprises at least one of steel (Fe), strontium (Sr), graphene, nickel (Ni), cobalt (Co), copper alloy, neodymium (Nd), dysprosium (Dy), or samarium (Sm).

3. The mask frame assembly of claim 1, wherein the polymer material comprises polyimide.

4. The mask frame assembly of claim 1, wherein the frame is coupled to an edge of the mask.

5. The mask frame assembly of claim 1, wherein a length of the magnetic element is smaller than a thickness of the polymer.

6. A method of manufacturing a mask frame assembly, the method comprising:
forming a polymer layer comprising a magnetic element on a glass substrate;
forming a pattern hole in the polymer layer;
coupling a frame to an edge of the polymer layer; and
separating the glass substrate from the polymer layer.

7. The method of claim 6, wherein the forming of the polymer layer comprises:
coating the glass substrate with a polymer solution comprising the magnetic element; and
solidifying the polymer solution coating the glass substrate.

8. The method of claim 6, wherein the forming of the pattern hole comprises at least one of laser patterning, lithography, or printing.

9. The method of claim 6, wherein the coupling of the frame comprises providing an attachment layer at an edge of the mask and attaching the frame to the attachment layer.

10. The method of claim 6, wherein the separating of the glass substrate from the polymer layer comprises emitting a laser to heat the glass substrate.
